(19) United States
(12) Patent Application Publication
(10) Pub. No.: US 2016/0012720 A1
(43) Pub. Date: Jan. 14, 2016

(54) REDUCING ROUTE CONGESTION DURING SIMULTANEOUS REROUTING EVENTS

(71) Applicant: INTERNATIONAL BUSINESS MACHINES CORPORATION, Armonk, NY (US)

(72) Inventors: Gregory Jensen Boss, Saginaw, MI (US); Andrew R. Jones, Round Rock, TX (US); Charles Steven Lingafelt, Durham, NC (US); Kevin C. McConnell, Austin, TX (US); John Elbert Moore, JR., Brownsburg, IN (US)

(21) Appl. No.: 14/330,478

(22) Filed: Jul. 14, 2014

(51) Int. Cl. G08G 1/01; G01C 21/20

(52) U.S. Cl. CPC G08G 1/0129; G01C 21/20

(57) ABSTRACT

A method and system of reducing route congestion due to a traffic event during simultaneous rerouting of a route by GPS devices. A computer receives information regarding the traffic event; predicts at least one GPS alternate route which a GPS device would recommend to a user to avoid the traffic event; predicts a number of users that would utilize the at least one GPS alternate route; finds at least one other alternate route; determines a number of existing vehicles already present on the GPS alternate route and on the at least one other alternate route; calculates a reroute weight for each of the GPS alternate routes, calculates modified traffic information for each of the GPS alternate routes by applying the reroute weight for the GPS alternate route to increase the real-time traffic data for the GPS alternate route; and sends the modified traffic information to the GPS devices.

### BACKGROUND

The present invention relates to global positioning systems (GPS) for vehicles, and more specifically to reducing route congestion of vehicles during simultaneous rerouting of vehicles in response to an event.

GPS devices include a rerouting functionality that allows users to be “rerouted” to their destination through an alternate path or route. The rerouting may be requested by the user or be based on current traffic conditions in which the vehicle is present in. When an event occurs, for example a traffic event, either through the user or the GPS device itself, a significant number of independently functioning GPS devices calculate the same reroute, to avoid the traffic event. With the reroute being followed by a proportion of the vehicles, the rerouted path also becomes significantly congested.

### SUMMARY

According to one embodiment of the present invention, a method of reducing route congestion due to a traffic event during simultaneous rerouting of routes by GPS devices. The method comprising the steps of: a computer receiving reroute proposals for rerouting of a route from a plurality of registered GPS devices to avoid the traffic event; the computer aggregating the reroute proposals from the plurality of registered GPS devices; the computer correlating the reroute proposals with real-time traffic data and historical and/or demographical traffic data to estimate a number of vehicles which are predicted to use each of the reroutes the in the plurality of reroute proposals; and based on the number of vehicles predicted to use the reroutes, the computer sending at least one alternative reroute to at least one of the registered GPS devices.

According to another embodiment of the present invention, a method of reducing route congestion due to a traffic event during simultaneous rerouting of a route by GPS devices. The method comprising the steps of: a computer receiving information regarding the traffic event; the computer predicting at least one GPS alternate route which a GPS device would recommend to a user to avoid the traffic event; the computer predicting a number of users that would utilize the at least one GPS alternate route; the computer finding at least one other alternate route; the computer determining a number of existing vehicles already present on the at least one GPS alternate route and on the at least one other alternate route; the computer calculating a reroute weight for each of the GPS alternate routes, the reroute weight for each GPS alternate route being proportional at least to the number of users that the computer predicted would utilize the GPS alternate route; the computer calculating modified traffic information for each of the GPS alternate routes by applying the reroute weight for the GPS alternate route to increase the real-time traffic data for the GPS alternate route; and the computer sending the modified traffic information to the GPS devices.

According to another embodiment of the present invention, a system for reducing route congestion due to a traffic event during simultaneous rerouting of a route by GPS devices comprising a computer comprising at least one processor, one or more memories, one or more computer readable storage media having program instructions executable by the computer to perform the program instructions. The program instructions comprising: receiving, by a computer, information regarding the traffic event; predicting, by the computer, at least one GPS alternate route which a GPS device would recommend to a user to avoid the traffic event; predicting, by the computer, a number of users that would utilize the at least one GPS alternate route; finding, by the computer, at least one other alternate route; determining, by the computer, a number of existing vehicles already present on the at least one GPS alternate route and on the at least one other alternate route; calculating, by the computer, a reroute weight for each of the GPS alternate routes, the reroute weight for each GPS alternate route being proportional at least to the number of users that the computer predicted would utilize the GPS alternate route; calculating, by the computer, modified traffic information for each of the GPS alternate routes by applying the reroute weight for the GPS alternate route to increase the real-time traffic data for the GPS alternate route; and sending, by the computer, the modified traffic information to the GPS devices.

### BRIEF DESCRIPTION OF THE SEVERAL VIEWS OF THE DRAWINGS

FIG. 1 depicts an exemplary diagram of a possible data processing environment in which illustrative embodiments may be implemented.

FIG. 2 shows a schematic of a rerouting system.

FIG. 3 shows a flow diagram of a method of reducing route congestion during simultaneous rerouting of routes through GPS devices associated with a central authority.

FIG. 4 shows a schematic of an alternative rerouting system.

FIG. 5 shows a flow diagram of a method of reducing route congestion during simultaneous rerouting of routes by GPS devices through prediction of the reroutes by a central authority.

FIG. 6 illustrates internal and external components of a client or device computer and a server computer in which illustrative embodiments may be implemented.

FIG. 7 shows a schematic of a map for illustrating an example of a method of reducing route congestion during simultaneous rerouting of routes through GPS devices associated with a central authority.

FIG. 8 shows a schematic of a map for illustrating an example of a method of reducing route congestion during simultaneous rerouting of routes by GPS devices through prediction of the reroutes by a central authority.

### DETAILED DESCRIPTION

In an illustrated embodiment of the present invention, it is recognized that coordination between GPS devices is beneficial in order to distribute the traffic across multiple alternative routes, yielding optimized travel time for vehicles, and reducing or eliminating congestion on the alternative route or reroute.

In another illustrated embodiment of the present invention, it is recognized that an “event” or “traffic event” is an occurrence that happens at a given place and time involving a vehicle, road network, or traffic device that may impede the time in which it will take a vehicle to travel from a first location to a second location, with the event being present between the first location and the second location. A “reroute” is an alternative path for the vehicle to travel from the first location to the second location which avoids or circumvents the traffic event.

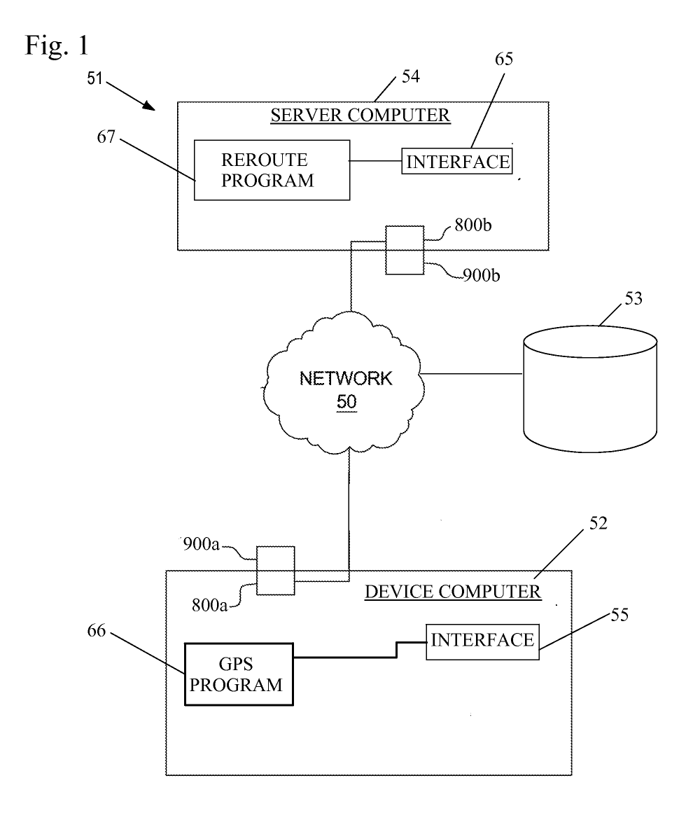

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

In the depicted example, device computer 52, a repository 53, and a server computer 54 connect to network 50. Also connected to a network may be a feed of real-time traffic information and monitoring services. In other exemplary embodiments, network data processing system 51 may include additional client or device computers, storage devices or repositories, server computers, and other devices not shown.

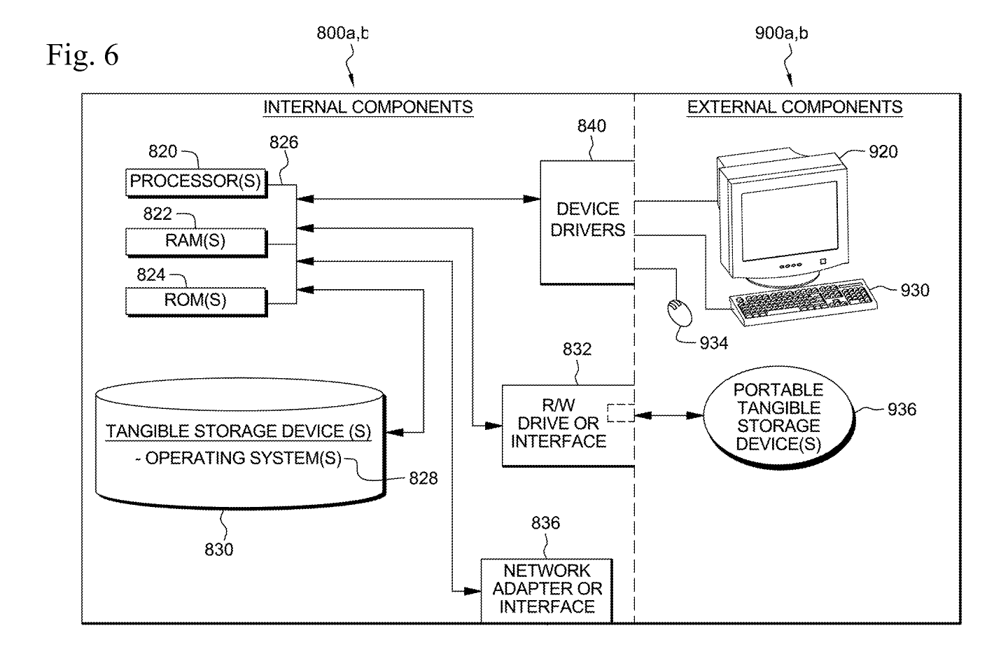

Device computer 52 includes a set of internal components 800a and a set of external components 900a, further illustrated in FIG. 6. Device computer 52 may be, for example, a mobile device, a cell phone, a personal digital assistant, a netbook, a laptop computer, a tablet computer, a desktop computer, a global position system (GPS) device or any other type of computing device.

Device computer 52 may contain an interface 55. The interface 55 may accept commands and data entry from a user. The interface 55 can be, for example, a command line interface, a graphical user interface (GUI), or a web user interface (WUI) through which a user can input a location in which they wish to travel to and/or register the GPS device as shown in FIG. 1, or alternatively on server computer 54. The device computer 52 preferably includes a GPS program 66. While not shown, it may be desirable to have the GPS program be present on the server computer 54.

Server computer 54 includes a set of internal components 800b and a set of external components 900b illustrated in FIG. 6. The server computer 54 may contain an interface 65. The interface 65 may accept commands and data entry. The interface 65 can be, for example, a command line interface, a graphical user interface (GUI), or a web user interface (WUI). The server computer 54 preferably includes a reroute program 67.

In the depicted example, server computer 54 provides information, such as boot files, operating system images, and applications to device computer 52. Server computer 54 can compute the information locally or extract the information from other computers on network 50.

Program code and programs such as a reroute program 67 and/or a GPS program 66 may be stored on at least one of one or more computer-readable tangible storage devices 830 shown in FIG. 6, on at least one of one or more portable computer-readable tangible storage devices 936 as shown in FIG. 6, on repository 53 connected to network 50, or downloaded to a data processing system or other device for use. For example, program code and programs such as a reroute program 67 and/or a GPS program 66 may be stored on at least one of one or more tangible storage devices 830 on server computer 54 and downloaded to the device computer 52. Alternatively, server computer 54 can be a web server, and the program code and programs such as a reroute program 67 and/or GPS program 66 may be stored on at least one of the one or more tangible storage devices 830 on server computer 54 and accessed on the device computer 52. Reroute program 67 and/or GPS program 66 can be accessed on device computer 52 through interface 55. In other exemplary embodiments, the program code and programs such as a reroute program 67 and/or GPS program 66 may be stored on at least one of one or more computer-readable tangible storage devices 830 on server computer 54 or distributed between two or more servers.

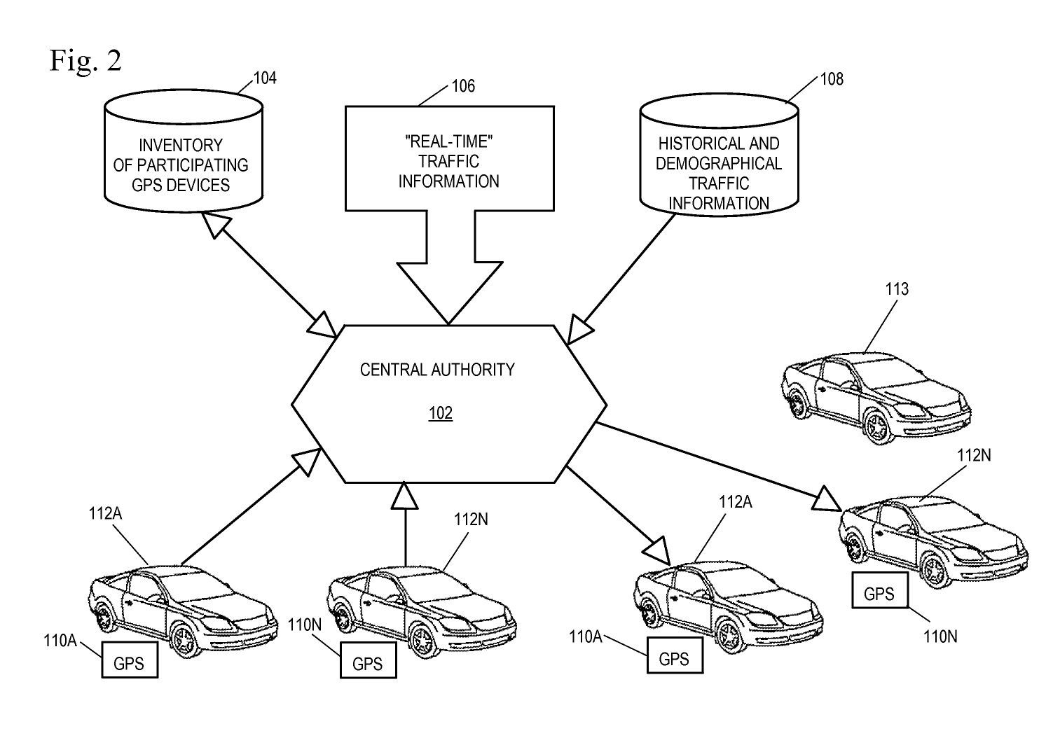

FIG. 2 shows a schematic of a rerouting system in an exemplary embodiment.

A central authority 102 is connected to an inventory of participating or registered GPS devices 104, “real-time” traffic information 106, historical and demographical traffic information 108, and cars 112a-112n with GPS devices 110a-110n that are registered with the central authority 102. The central authority 102 preferably includes a reroute program 67 that may be used to reroute GPS devices 110a-110n to use alternate reroutes. The central authority 102 can communicate with the GPS devices 110a-110n through cell-phone data services, General Packet Radio Service (GPRS), satellite radio links, or some other bidirectional radio service.

In this embodiment, the central authority 102 calculates reroutes for registered GPS devices to reduce route congestion of vehicles 112a-112n during simultaneous rerouting of vehicles in response to an event. The central authority 102 does not communicate with non-registered GPS devices or vehicles 113 that do not have a GPS device.

The inventory of participating GPS devices and the historical and demographical traffic information may be stored in a repository, such as repository 53 of FIG. 1.

The real-time traffic information may be received from various sources, which may include, but is not limited to data from the Department of Transportation, sensors within the roads, and private aggregator companies. The real-time data may also be derived from the actual positions and speeds reported by participating GPS devices, or by data supplied by the users of the GPS devices in real time.

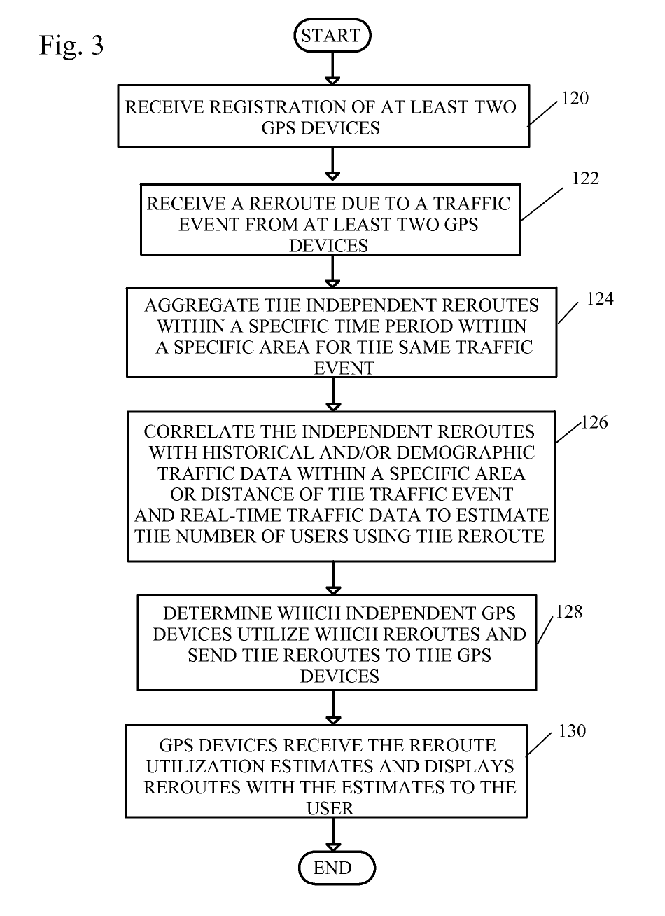

FIG. 3 shows a flow diagram of a method of reducing route congestion during simultaneous rerouting of routes through GPS devices associated with a central authority, for example the central authority of FIG. 2.

In a first step, the central authority 102 receives a registration of at least two GPS devices and stores the registration in a repository (step 120), for example the inventory of participating GPS devices 104.

The central authority 102 receives a reroute proposal due to a traffic event from at least two registered GPS devices (step 122). The central authority 102, for example through the reroute program 67, aggregates the independent reroute proposals within a specific time period within a specific area for the same traffic event (step 124). The specific time period and distance or radius of the specific area is predetermined and may vary based on location and weather conditions.

The central authority 102, for example through the reroute program 67, correlates the independent reroute proposals from the registered GPS devices with historical and/or demographical traffic data within a specific area or distance of the traffic event and with real-time traffic data to estimate the number of users, both registered and unregistered using the reroute (step 126). The registered and unregistered users are both considered to maintain a more accurate representation of the number of users using the reroutes and the possible traffic distribution on the reroutes.

The central authority 102, for example through the reroute program 67, determines or correlates which registered, independent GPS devices are using what reroute and sends at least one alternative reroute for the registered GPS devices to utilize if the estimated number of unregistered users is above a threshold and sends the alternate reroutes to the registered GPS devices (step 128).

The GPS devices receive the alternate reroute utilization estimates and displays the estimates with the alternate reroutes to a user (step 130), for example by the GPS program 66 through the interface 55 and the method ends. The user of the GPS device may or may not use the alternate reroute.

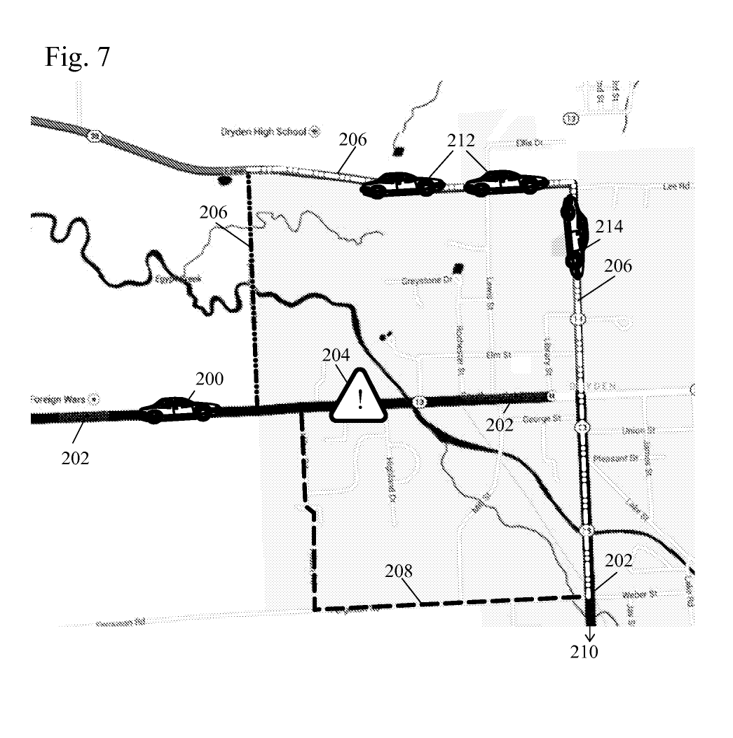

FIG. 7 shows a map illustrating an example of the method of FIG. 3. A vehicle 200 with a registered GPS device is traveling on a primary route 202 to a destination 210. A traffic event 204 is present on the primary route 202. The registered GPS device sends a proposal for a reroute 206 to the central authority 102. The reroute 206 proposed by the GPS device is indicated in FIG. 7 by the dash-dot-dot line.

The central authority 102 aggregates the reroutes 206 proposed by registered GPS devices and correlates the reroutes with historical and/or demographical traffic data and real-time traffic data to estimate the number of vehicles using the reroute 206 which are not registered with the central authority 102. In this example, on the reroute 206, there are three vehicles 212, 214. One of the vehicles 214 has a GPS device that is registered with the central authority and the other vehicles 212 do not.

Based on the proposed reroute 206 and the estimate of the number of users utilizing the reroute 206, the central authority 102 sends an alternate reroute 208 to the vehicle 200 with the registered GPS device which avoids the traffic on the originally proposed reroute 206. The alternate reroute 208, indicated in the figure by the dashed line, does not have any traffic and provides an alternate route the destination 210.

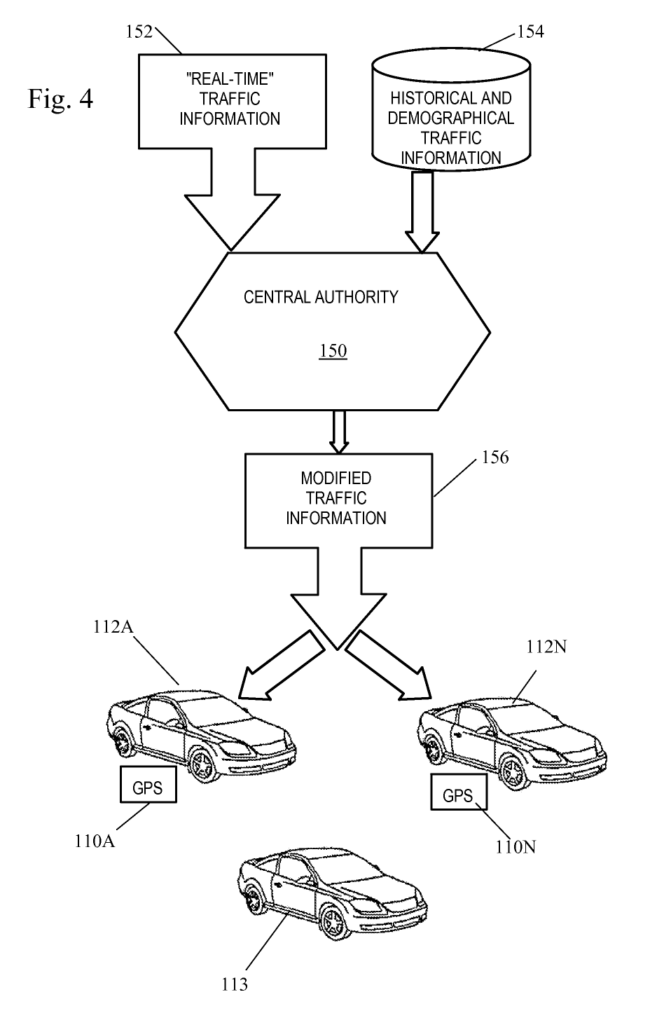

FIG. 4 shows a schematic of an alternative rerouting system.

A central authority 150 is connected to “real-time” traffic information 152 and historical and demographical traffic information 154. The central authority 150 uses the “real-time” traffic information and the historical and demographical traffic information to predict the routes a plurality of independent GPS devices 110a-110n of vehicles 112a-112n would utilize as well as to determine a preferred reroute, for example by the reroute program 67.

The central authority 150 can communicate with the GPS devices 110a-110n through a conventional cell-phone network, General Packet Radio Service (GPRS), satellite radio, or through data sent through some other broadcast radio system such as a subcarrier or additional data, for example communicate with the GPS devices 110a-110n through cell-phone data services, General Packet Radio Service (GPRS), satellite radio links, or some other bidirectional radio service.

The inventory of participating GPS devices and the historical and demographical traffic information may be stored in a repository, such as repository 53 of FIG. 1.

The real-time traffic information may be received from various sources, which may include, but is not limited to data from the Department of Transportation, sensors within the roads, and private aggregator companies.

The central authority 150 generates modified traffic information 156 to send to independent GPS devices 110a-110n, which causes the GPS devices 110a-110n to reroute to the preferred route of the central authority 150. It should be noted that the modified traffic information 156 is not true, current traffic information, but is based on the real-time traffic information, which is altered by the central authority 150 to cause the independent GPS devices 110a-110n to switch the route to the preferred reroute calculated or determined by the central authority 150.

The modified traffic information 156 may be tagged to identify it as modified or it may be encrypted to prevent its use by unauthorized systems, for example vehicle 113.

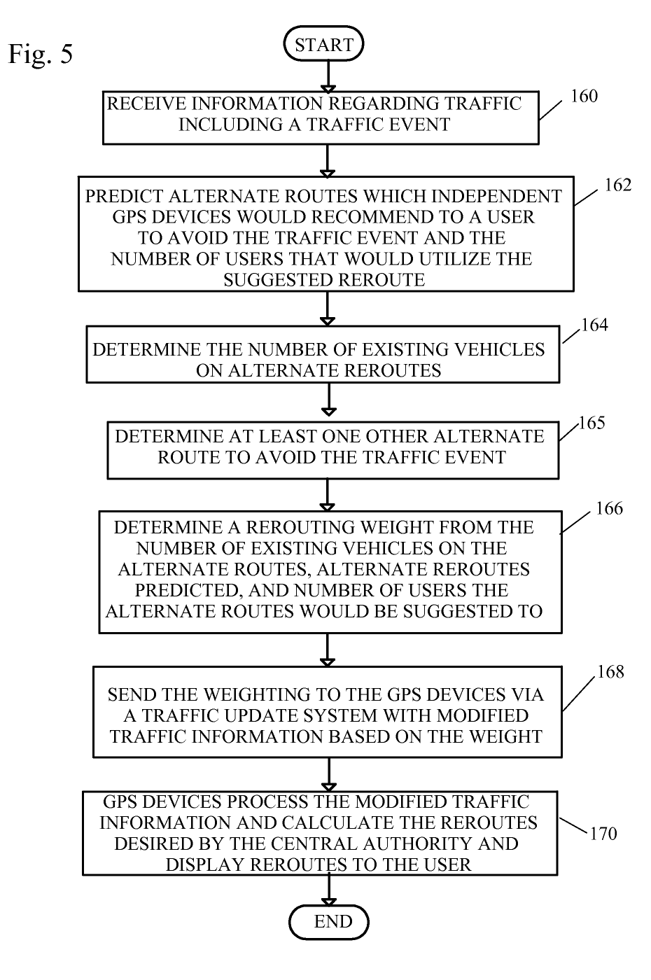

FIG. 5 shows a flow diagram of a method of reducing route congestion during simultaneous rerouting of routes by GPS devices through prediction of the reroutes by a central authority.

It should be noted that prior to step 160 discussed below, the central authority 150 may determine, for each physical route, alternate routes which independent GPS devices not privy to the modified information 156 may suggest to their users.

Also prior to step 160, an alternate route allocation calculation method may be predetermined. The alternate route allocation calculation and thus the calculation of the weight may attempt to minimize the total average travel time across all GPS devices, minimize the total distance traveled, or minimize time for the “privileged” GPS devices in which the users paid for a service at the expense of the “non-privileged” users that did not pay for the service. The “privileged” GPS devices may also receive more advantageous reroutes than the “non-privileged” GPS devices. Alternatively, the weighting may be based on a reservation system, in which a number of factors can determine which vehicles would be considered “privileged” versus “non-privileged”, for example distance to travel, day of the week, or even job type. It should be noted that some feedback from the GPS devices may occur and be incorporated into the real-time traffic data.

The central authority 150 receives information regarding traffic including a traffic event (step 160). The information may include “real-time” traffic information and historical and demographical traffic information.

The central authority 150 predicts, for example through the reroute program 67, at least one alternate route in which independent GPS devices would recommend to the a user to avoid or rerouted around the traffic event and the number of users that would utilize the suggested reroute (step 162).

The central authority 150, through the reroute program and the “real-time” traffic information determines or predicts the number of existing vehicles that would utilize the alternate route (step 164).

The central authority 150 finding at least one other alternate route to avoid the traffic event (step 165).

The central authority 150 determines a rerouting weight from the number of existing vehicles on the alternate routes, alternate reroutes predicted, and the number of users the alternate routes would be suggested to (step 166), for example through the reroute program 67. The weighting may be calculated using historical data or metering.

The weighting is sent to the GPS devices via a traffic update system with modified traffic information 156 based on the weight (step 168), for example with the reroute program 67.

The weighting is used to skew or favor the (modified) traffic information to simulate the presence of the unregistered vehicles that the other GPS systems have told to use the same route, such that the registered GPS device receiving the modified data will suggest a reroute designated by the central authority 150 instead of the one it would normally suggest based on the actual real-time data. The weighting may be represented to the GPS device as additional virtual traffic on the route, or reporting slower speeds than is actually reported in the live or real-time traffic feeds.

The GPS devices process the modified traffic information, calculate reroutes and display them to the user, for example through the GPS program 66 and interface 55. Then the method ends or repeats back from the beginning.

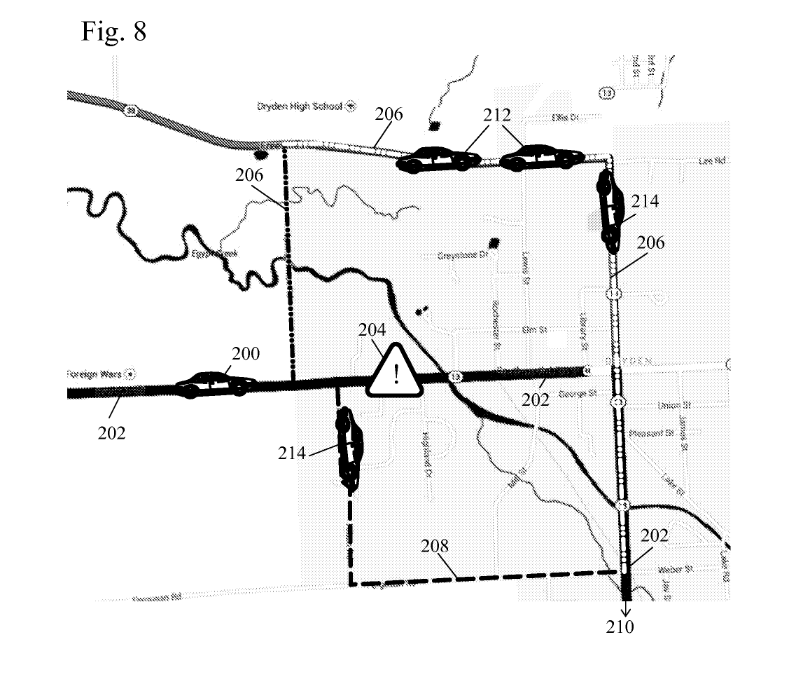

FIG. 8 shows a schematic of a map illustrating an example of the method of FIG. 5. The central authority 150 receives information regarding a traffic event 204 on a primary route 202, indicated by a solid line. The central authority 150 predicts alternate routes 206 (indicated by a dash-dot-dot line) and 208 (indicated by a dashed line) which independent GPS devices would recommend to a user to avoid the traffic event, as well as the number of users that would utilize the suggested route. The central authority 150 uses real-time traffic information to determine the number of existing vehicles on the routes. In this example, on route 206 there are three vehicles and on route 208 there is one vehicle.

The central authority 150 determines a rerouting weight from the number of existing vehicles on the reroutes, the reroutes predicted, and the number of users to whom the alternate routes would be suggested. In this example, the rerouting weight of route 206 may be 0.75 and the rerouting weight of route 208 may be 0.25. The rerouting weight is applied to the real-time traffic data sent to the vehicles, for example vehicles 200 and 214 with GPS devices registered for this service, via a traffic update which sends the modified traffic information to the GPS devices in the vehicles. In other words, the rerouting weight for route 206 may be sent to the GPS device as reporting slower speeds of the vehicles on route 206 that actually occurring, or represent route 206 as having twenty vehicles instead of three.

The GPS device receives the modified traffic information and recalculates or provides an alternate reroute. For example in this example, the GPS in vehicle 200 would have suggested a reroute to route 206, absent the modification to the traffic data, because route 206 is the larger and faster road. The central server modifies the real-time traffic data to indicate route 206 is slower than it actually is, so that the GPS device in vehicle 200 chooses to reroute via route 208 (normally a second choice because it is a minor back road with a lower speed limit) instead.

FIG. 6 illustrates internal and external components of device computer 52 and server computer 54 in which illustrative embodiments may be implemented. In FIG. 6, device computer 52 and server computer 54 include respective sets of internal components 800a, 800b and external components 900a, 900b. Each of the sets of internal components 800a, 800b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828, reroute program 67 and GPS program 66 are stored on one or more of the computer-readable tangible storage devices 830 for execution by one or more of the processors 820 via one or more of the RAMs 822 (which typically include cache memory). In the embodiment illustrated in FIG. 6, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b also includes a R/W drive or interface 832 to read from and write to one or more portable computer-readable tangible storage devices 936 such as a CD-ROM, DVD, memory stick, magnetic tape, magnetic disk, optical disk or semiconductor storage device. Reroute program 67 and GPS program 66 can be stored on one or more of the portable computer-readable tangible storage devices 936, read via R/W drive or interface 832 and loaded into hard drive 830.

Each set of internal components 800a, 800b also includes a network adapter or interface 836 such as a TCP/IP adapter card. Reroute program 67 and GPS program 66 can be downloaded to the device computer 52 and server computer 54 from an external computer via a network (for example, the Internet, a local area network or other, wide area network) and network adapter or interface 836. From the network adapter or interface 836, reroute program 67 and GPS program 66 are loaded into hard drive 830. The network may comprise copper wires, optical fibers, wireless transmission, routers, firewalls, switches, gateway computers and/or edge servers.

Each of the sets of external components 900a, 900b includes a computer display monitor 920, a keyboard 930, and a computer mouse 934. Each of the sets of internal components 800a, 800b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Reroute program 67 and GPS program 66 can be written in various programming languages including low-level, high-level, object-oriented or non object-oriented languages. Alternatively, the functions of a reroute program 67 and GPS program 66 can be implemented in whole or in part by computer circuits and other hardware (not shown).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having thus described the invention of the present application in detail and by reference to embodiments thereof, it will be apparent that modifications and variations are possible without departing from the scope of the invention defined in the appended claims.

What is claimed is:

1. A method of reducing route congestion due to a traffic event during simultaneous rerouting of routes by GPS devices comprising the steps of:
a computer receiving reroute proposals for rerouting of a route from a plurality of registered GPS devices to avoid the traffic event;
the computer aggregating the reroute proposals from the plurality of registered GPS devices;
the computer correlating the reroute proposals with real-time traffic data and historical and/or demographical traffic data to estimate a number of vehicles which are predicted to use each of the reroutes the in the plurality of reroute proposals; and
based on the number of vehicles predicted to use the reroutes, the computer sending at least one alternative reroute to at least one of the registered GPS devices.

2. The method of claim 1, wherein prior to the computer receiving the reroute proposals from the plurality of registered GPS devices, the method comprising the steps of:
the computer receiving a registration from a GPS device; and
the computer storing the GPS as a registered GPS device in a repository of registered devices.

3. A method of reducing route congestion due to a traffic event during simultaneous rerouting of a route by GPS devices comprising the steps of:
a computer receiving information regarding the traffic event;
the computer predicting at least one GPS alternate route which a GPS device would recommend to a user to avoid the traffic event;
the computer predicting a number of users that would utilize the at least one GPS alternate route;
the computer finding at least one other alternate route;
the computer determining a number of existing vehicles already present on the at least one GPS alternate route and on the at least one other alternate route;
the computer calculating a reroute weight for each of the GPS alternate routes, the reroute weight for each GPS alternate route being proportional at least to the number of users that the computer predicted would utilize the GPS alternate route;
the computer calculating modified traffic information for each of the GPS alternate routes by applying the reroute weight for the GPS alternate route to increase the real-time traffic data for the GPS alternate route; and
the computer sending the modified traffic information to the GPS devices.

4. The method of claim 3, wherein the weight is calculated by incorporating the number of existing vehicles on the alternate route, the alternate routes predicted, and the number of used the alternate routes would be presented to.

5. The method of claim 3, wherein the modified traffic information for a GPS alternate route is calculated by including additional virtual traffic to the real-time traffic data based on the reroute weight.

6. The method of claim 3, wherein the modified traffic information for a GPS alternate route is calculated by reducing reporting slower speeds of vehicles from the real-time traffic data based on the reroute weight.

7. The method of claim 3, further comprising the step of a GPS computer recalculating GPS reroutes using modified data to determine an alternate reroute.

8. A computer system for reducing route congestion due to a traffic event during simultaneous rerouting of a route by GPS devices comprising a computer comprising at least one processor, one or more memories, one or more computer readable storage media having program instructions executable by the computer to perform the program instructions comprising:
receiving, by a computer, information regarding the traffic event;
predicting, by the computer, at least one GPS alternate route which a GPS device would recommend to a user to avoid the traffic event;
predicting, by the computer, a number of users that would utilize the at least one GPS alternate route;
finding, by the computer, at least one other alternate route;
determining, by the computer, a number of existing vehicles already present on the at least one GPS alternate route and on the at least one other alternate route;
calculating, by the computer, a reroute weight for each of the GPS alternate routes, the reroute weight for each GPS alternate route being proportional at least to the number of users that the computer predicted would utilize the GPS alternate route;
calculating, by the computer, modified traffic information for each of the GPS alternate routes by applying the reroute weight for the GPS alternate route to increase the real-time traffic data for the GPS alternate route; and
sending, by the computer, the modified traffic information to the GPS devices.

9. The computer system of claim 8, wherein the weight is calculated by incorporating the number of existing vehicles on the alternate route, the alternate routes predicted, and the number of used the alternate routes would be presented to.

10. The computer system of claim 8, wherein the modified traffic information for a GPS alternate route is calculated by including additional virtual traffic to the real-time traffic data based on the reroute weight.

11. The computer system of claim 8, wherein the modified traffic information for a GPS alternate route is calculated by reducing reporting slower speeds of vehicles from the real-time traffic data based on the reroute weight.

12. The computer system of claim 8, further comprising program instructions of recalculating, by a GPS computer, GPS reroutes using modified data to determine an alternate reroute.
